(19) United States
(12) Patent Application Publication
(10) Pub. No.: US 2018/0237686 A1
(43) Pub. Date: Aug. 23, 2018

(54) METHOD FOR STIMULATION TREATMENT USING POLYMER-SURFACTANT COMBINATION

(71) Applicant: Halliburton Energy Services, Inc., Houston, TX (US)

(72) Inventors: Eli Allen Schnoor, Kingwood, TX (US); Dipti Singh, Kingwood, TX (US); Prashant D. Chopade, Kingwood, TX (US); Ali Alwattari, The Woodlands, TX (US)

(73) Assignee: Halliburton Energy Services, Inc., Houston, TX (US)

(21) Appl. No.: 15/754,251

(22) PCT Filed: Aug. 31, 2015
(86) PCT No.: PCT/US2015/047725

§ 371 Date: Feb. 21, 2018

(51) Int. Cl. C09K 8/68; C09K 8/90; E21B 43/267

(52) U.S. Cl. CPC C09K 8/68; C09K 8/90; C09K 8/80; C09K 2208/04; C09K 2208/30; E21B 43/267

(57) ABSTRACT

A method of treating in a subterranean formation including combining an aqueous base fluid and an anionic surfactant to form a first solution; hydrating a cationic polymer with the first solution to form a viscous fluid; combining the viscous fluid with a proppant thereby forming a treatment fluid; and introducing the treatment fluid into the subterranean formation. A method of making a well treatment fluid including combining an aqueous base fluid and an anionic surfactant to form a first solution; hydrating a cationic polymer with the first solution to form a viscous fluid; and combining the viscous fluid with a proppant thereby forming a treatment fluid.

### BACKGROUND

The present invention generally relates to the use of treatment fluids in subterranean operations, and, more specifically, to methods of using these treatment fluids in subterranean operations.

Subterranean wells (e.g., hydrocarbon fluid producing wells and water producing wells) are often stimulated by hydraulic fracturing treatments. In a typical hydraulic fracturing treatment, a treatment fluid is pumped into a wellbore in a subterranean formation at a rate and pressure above the fracture gradient of the particular subterranean formation so as to create or enhance at least one fracture therein. Particulate solids (e.g., graded sand, bauxite, ceramic, nut hulls, and the like), or “proppant particulates,” are typically suspended in the treatment fluid or a second treatment fluid and deposited into the fractures while maintaining pressure above the fracture gradient. The proppant particulates are generally deposited in the fracture in a concentration sufficient to form a tight pack of proppant particulates, or “proppant pack,” which serves to prevent the fracture from fully closing once the hydraulic pressure is removed. By keeping the fracture from fully closing, the interstitial spaces between individual proppant particulates in the proppant pack form conductive pathways through which produced fluids may flow.

The rheological requirements of a fracture fluid are highly constraining. To adequately propagate fractures in the subterranean formation, a fracturing fluid should exhibit a low leakage rate of liquids into the formation during the fracturing operation. Also, the fracturing fluid should have sufficient body and viscosity to transport and deposit proppant into the cracks in the formation formed during fracturing. The fracturing fluid should readily flow back into the wellbore after the fracturing is complete and leave minimal residue that could impair permeability and conductivity of the formation. Finally, the fracturing fluid should have rheological characteristics that permit it to be formulated and pumped down the wellbore without excessive difficulty or pressure drop friction losses.

Several techniques have evolved for treating a subterranean well formation to stimulate hydrocarbon production. For example, hydraulic fracturing methods have often been used according to which a portion of a formation to be stimulated is isolated using conventional packers, or the like, and a stimulation fluid containing gels, acids, sand slurry, and the like, is pumped through the well bore into the isolated portion of the formation. The pressurized stimulation fluid pushes against the formation at a very high force to establish and extend cracks on the formation. However, the requirement for isolating the formation with packers is time consuming and considerably adds to the cost of the system.

One of the problems often encountered in hydraulic fracturing is fluid loss which for the purposes of this application is defined as the loss of the stimulation fluid into the porous formation or into the natural fractures existing in the formation. These fluids are typically composed of a polysaccharide polymer and a crosslinking agent which binds individual polymer chains together which can result in an exponential increase in viscosity. These polymers are traditionally crosslinked in one of two ways; either with borate or metal cations (e.g. Zr, Al, Ti, etc.). The most commonly used fracturing fluids are water-based compositions containing a hydratable high molecular weight polymeric gelling material that increases the viscosity of the fluid. Thickening the fluid reduces leakage of liquids from the fracture fissures into the formation during fracturing and increases proppant suspension capability.

However, the traditional metal crosslinked fluids are not very shear tolerant, and can be permanently damaged by high shear. They are also subject to degradation as the temperature increases. Thus, a method of using a high viscosity treatment fluid is needed that can withstand high shear and increases in temperature without relying exclusively on borate or metal cations for crosslinking.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 depicts the results of adding a surfactant to a hydrated polymer under a moderate shear rate.

FIGS. 2A-B depict a surfactant added to a hydrated polymer and a polymer hydrated in water containing a surfactant.

FIG. 3 is a graph demonstrating the effect of an anionic surfactant addition on the viscosity of a Cat-HEC polymer system.

FIG. 4 depicts an embodiment of a system configured for delivering the treatment fluids of the embodiments described herein to a downhole location.

FIGS. 5A-D depict photographs various combinations Cat-HEC and surfactants in a proppant.

FIG. 6 is a graph of viscosity vs. time of Cat-HEC/surfactant fluids at various temperatures.

FIG. 7 is a graph of viscosity vs time of Cat-HEC/surfactant fluids at various shear rates.

### DETAILED DESCRIPTION

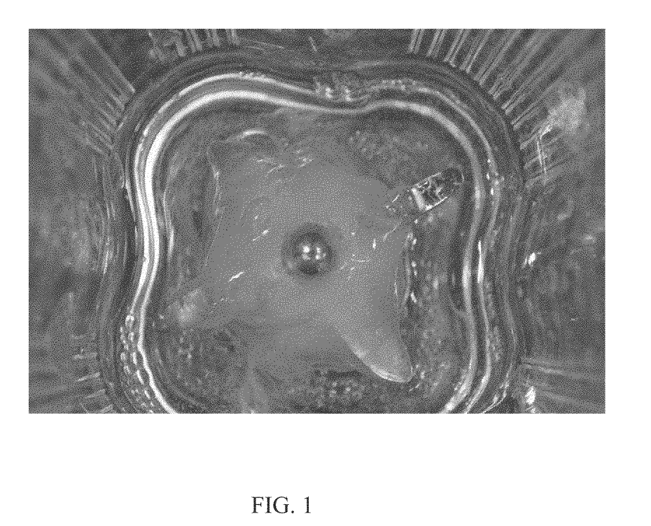

Embodiments of the disclosure are directed polymer-surfactant systems could introduce a new method of building high viscosity fluids compared to traditional borate and metal crosslinked systems. When an anionic surfactant for foam stabilization was added to a hydrated cationic-HEC polymer (Cat-HEC) localized viscous domains were generated resulting heterogeneous gel structure. Increase in fluid viscosity was noticed as soon as the anionic surfactant was added, but it contained heterogeneous domains. Along with this tendency to form heterogeneous mixtures resulting in low fluid viscosity, this method of addition led to the precipitation of some of the hydrated polymer in the form of fibrous knots if the fluid was not sheared at a very high rates. FIG. 1 shows a fibrous mass deposited on blender blades upon adding an anionic surfactant to a hydrated Cat-HCE polymer under a moderate shear rate.

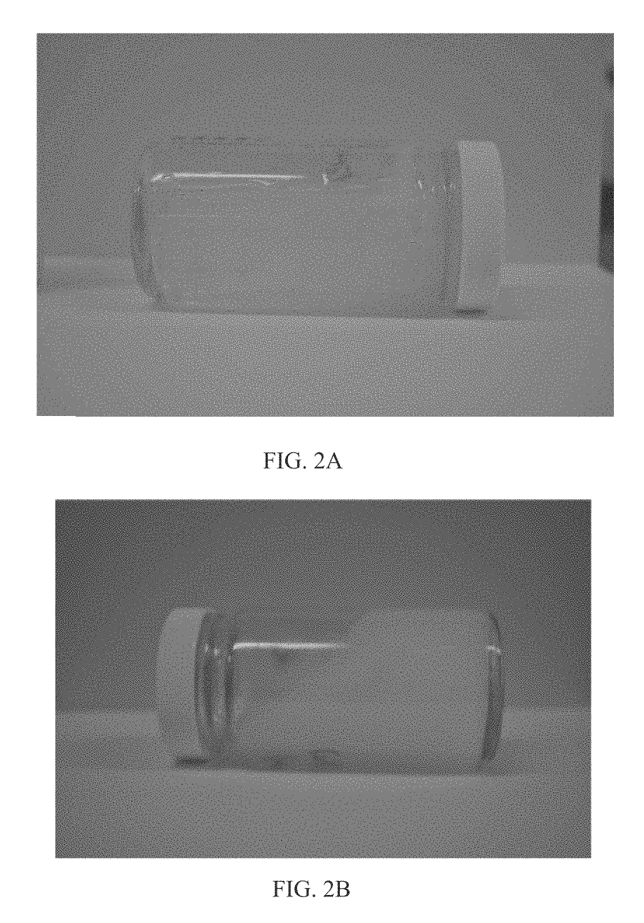

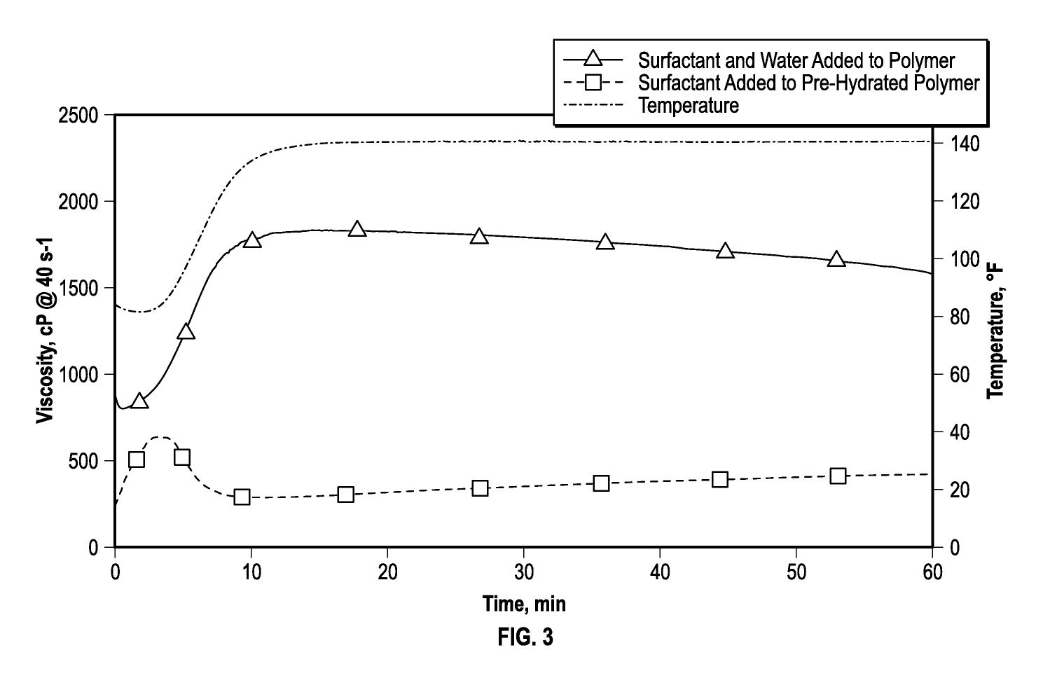

An alternate addition sequence was devised to mitigate the issues of gel consistency and precipitation. The anionic surfactant was dispersed in water prior to the addition of the Cat-HEC polymer. As the polymer hydrated in the presence of the anionic surfactant, a highly viscous, homogeneous network was formed which surpassed the viscosity and performance of the system created by adding the surfactant to the hydrated polymer. FIG. 2A shows a sample of fluid prepared by the addition of an anionic surfactant to a hydrated Cat-HEC polymer, and FIG. 2B shows a sample of a fluid with a Cat-HEC polymer hydrated in water containing the anionic surfactant. The method demonstrated in FIG. 2A produces a heterogeneous gel network, whereas, the method in FIG. 2B results in a highly viscous homogeneous gel network. Similarly, FIG. 3 is a graph demonstrating the effect of an anionic surfactant addition on the viscosity of a 30 lb/1000 gal Cat-HEC polymer system. The results indicate higher viscosities for fluids where the anionic surfactant is added to water prior to the Cat-HEC polymer hydration.

In an embodiment, a method of treating in a subterranean formation comprises: combining an aqueous base fluid and an anionic surfactant to form a first solution; hydrating a cationic polymer with the first solution to form a viscous fluid; combining the viscous fluid with a proppant thereby forming a treatment fluid; and introducing the treatment fluid into the subterranean formation. The aqueous base fluid may comprise at least one fluid selected from water, brine, slick water, and combinations thereof. In another embodiment, the aqueous base fluid may further comprise at least one of glycerin, propylene glycol, and combinations thereof. In some embodiments, the anionic surfactant may comprise at least one selected from the group consisting of alpha olefin sulfonate, alkylether sulfates, alkyl phosphonates, alkane sulfonates, fatty acid salts, and arylsulfonic acid salts, and mixtures thereof. In a preferred embodiment, the anionic surfactant comprises diethylene glycol, ethylene glycol monobutyl ether, an α-olefin sulfonate, and water. In an exemplary embodiment, the anionic surfactant comprises about 10% diethylene glycol, about 30% ethylene glycol monobutyl ether, about 45% α-olefin sulfonate, and about 15% water. In certain embodiments, the cationic polymer is partially hydrated before it is combined with the first solution. The proppants may be at least one selected from the group consisting of sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combination thereof. In an embodiment, the cationic polymer comprises at least one selected from the group consisting of cationic polyacrylamide copolymers, cationic guar, cationic cellulose derivatives, cationic polysaccharide derivatives, choline methacrylate, alkyl substituted nitrogen compounds, aryl substituted nitrogen compounds, alkyl-aryl substituted nitrogen compounds, and mixtures thereof. In a preferred embodiment, the cationic polymer is cationic hydroxyl ethyl cellulose. In some embodiments, the subterranean formation may comprise at least one fracture and wherein the introducing further comprises placing at least a portion of the treatment fluid into the at least one fracture. In another embodiment, the method further comprises adding a consolidating agent to the treatment fluid at a time of at least one of before the introducing of the treatment fluid into the subterranean formation, during the introducing of the treatment fluid, after the introducing the treatment fluid, and combinations thereof. The combining, hydrating, and introducing may utilize at least one of a pump, a mixer, and combinations thereof.

In certain embodiments of the present disclosure, a method of making a well treatment fluid comprises: combining an aqueous base fluid and an anionic surfactant to form a first solution; hydrating a cationic polymer with the first solution to form a viscous fluid; and combining the viscous fluid with a proppant thereby forming a treatment fluid. The aqueous base fluid may comprise at least one fluid selected from water, brine, slick water, and combinations thereof. In another embodiment, the aqueous base fluid may further comprise at least one of glycerin, propylene glycol, and combinations thereof. In some embodiments, the anionic surfactant may comprise at least one selected from the group consisting of alpha olefin sulfonate, alkylether sulfates, alkyl phosphonates, alkane sulfonates, fatty acid salts, and arylsulfonic acid salts, and mixtures thereof. In a preferred embodiment, the anionic surfactant comprises diethylene glycol, ethylene glycol monobutyl ether, an α-olefin sulfonate, and water. In an exemplary embodiment, the anionic surfactant comprises about 10% diethylene glycol, about 30% ethylene glycol monobutyl ether, about 45% α-olefin sulfonate, and about 15% water. In certain embodiments, the cationic polymer is partially hydrated before it is combined with the first solution. The proppants may be at least one selected from the group consisting of sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combination thereof. In an embodiment, the cationic polymer comprises at least one selected from the group consisting of cationic polyacrylamide copolymers, cationic guar, cationic cellulose derivatives, cationic polysaccharide derivatives, choline methacrylate, alkyl substituted nitrogen compounds, aryl substituted nitrogen compounds, alkyl-aryl substituted nitrogen compounds, and mixtures thereof. In a preferred embodiment, the cationic polymer is cationic hydroxyl ethyl cellulose. The combining and hydrating may utilize at least one of a pump, a mixer, and combinations thereof.

Some embodiments of the present invention provide a method of treating in a subterranean formation comprising: combining an aqueous base fluid and an anionic surfactant to form a first solution; hydrating a cationic polymer with the first solution to form a viscous fluid; combining the viscous fluid with a proppant thereby forming a treatment fluid; and introducing the treatment fluid into the subterranean formation under conditions effective to create at least one fracture therein.

Aqueous Base Fluids

The aqueous base fluid of the present embodiments can generally be from any source, provided that the fluids do not contain components that might adversely affect the stability and/or performance of the treatment fluids of the present invention.

In various embodiments, the aqueous base fluid can comprise fresh water, salt water, seawater, brine, or an aqueous salt solution. In some embodiments, the aqueous base fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like.

In some embodiments, the aqueous base fluid is present in the treatment fluids in the amount of from about 20% to about 99% by volume of the entire fluid system.

Cationic Polymers

In an embodiment, the present disclosure utilizes cationic polymers to increase the viscosity in the fluids. A proppant typically has a much higher density than water. For example, sand has a specific gravity of about 2.7. Any such proppant suspended in the water will tend to separate quickly and settle out from the water very rapidly. To help suspend the proppant in a water-based fracturing fluid, it is common to use a viscosity-increasing agent for the purpose of increasing the viscosity of water. The viscosity-increasing agent is sometimes known in the art as a “thickener.”

A viscosity-increasing agent is a chemical additive that alters fluid rheological properties to increase the viscosity of the fluid. A viscosity-increasing agent can be used to increase the viscosity, which increased viscosity can be used, for example, to help suspend a proppant material in the treatment fluid.

Because of the high volume of fracturing fluid typically used in fracturing, it is desirable to increase the viscosity of fracturing fluids efficiently in proportion to the concentration of the viscosity-increasing agent. Being able to use only a small concentration of the viscosity-increasing agent requires less total amount of the viscosity-increasing agent to achieve the desired fluid viscosity in a large volume of fracturing fluid. Efficient and inexpensive viscosity-increasing agents include water-soluble polymers such as guar gum. Other types of viscosity-increasing agents, such as viscoelastic surfactants, can also be used for various reasons, for example, in high-temperature applications.

A “base gel” is a fluid that includes a viscosity-increasing agent, such as guar, but that excludes, for example, fluids that are typically referred to as “cross-linked gels” and “surfactant gels.”

In the aqueous based fluid embodiments, a variety of gelling agents may be used, including hydratable polymers that contain one or more functional groups such as hydroxyl, carboxyl, sulfate, sulfonate, amino, or amide groups. Suitable gelling agents typically comprise natural polymers, synthetic polymers, or a combination thereof. A variety of gelling agents can be used in conjunction with the methods and compositions of the present invention, including, but not limited to, hydratable polymers that contain one or more functional groups such as hydroxyl, cis-hydroxyl, carboxylic acids, derivatives of carboxylic acids, sulfate, sulfonate, phosphate, phosphonate, amino, or amide. In certain exemplary embodiments, the gelling agents may be polymers comprising polysaccharides, and derivatives thereof that contain one or more of these monosaccharide units: galactose, mannose, glucose, xylose, arabinose, fructose, glucuronic acid, or pyranosyl sulfate. Examples of suitable polymers include, but are not limited to, xanthan, guar, guar derivatives (such as hydroxypropyl guar, carboxymethyl guar, and carboxymethylhydroxypropyl guar), and cellulose derivatives (such as hydroxyethyl cellulose and carboxylmethyl hydroxy ethyl cellulose). Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, and polyvinylpyrrolidone.

The aqueous base fluid may include aqueous linear gels, aqueous linear polysaccharide gels, aqueous linear guar gels, slick water, water, brine, viscoelastic surfactant solution, and combinations thereof. A commercially available aqueous gel includes, but is not limited to, OmegaFrac™ fluid system, available from Halliburton Energy Services, Houston, Tex.

In certain embodiments, derivatized cellulose, for example hydroxyl alkyl cellulose or polymers with cellulose backbone and cationic groups, are added through quaternization. Additionally cationic galacto-mannose may also be used as a cationic polymer in some embodiments.

Typically, the cationic substituents suitable for use comprise nitrogen. For example, the cationic substituents may be selected from the group consisting of alkyl substituted nitrogen compounds, aryl substituted nitrogen compounds or alkyl-aryl substituted nitrogen compounds. Often, the derivatizing reagents used to provide the cationic substituents are alkyl substituted nitrogen halides such as, for example, (2,3-Epxoypropyl) trimethyl ammonium chloride available as a 70 wt % solids solution from Degussa Corporation as QUAB™ 151.

In an exemplary embodiment, cationic hydroxyethylcellulose (cationic-HEC) is utilized. Other examples of useful cationic polymers include, but are not limited to, quaternary hydroxyl alkyl cellulose (Soft CAT-DOW, Sensomer™-Merquat-Lubrizol), cationic polygalactomannan gum are also available as trade name of Jaguar; amine treated cationic starches; ethanol, 2,2′,2″-nitrilotris-, polymer with 1,4-dichloro-2-butene and N,N,N′,N′-tetramethyl-2-butene-1,4-diamine; poly[bis(2-chloroethyl) ether-alt-1,3-bis[3-(dimethylamino)propyl]urea]; hydroxyethyl cellulose dimethyl diallylammonium chloride copolymer; diallyldimethylammonium chloride-hydroxyethyl cellulose copolymer; copolymer of acrylamide and quaternized dimethylammoniumethyl methacrylate; poly(diallyldimethylammonium chloride); copolymer of acrylamide and diallyldimethylammonium chloride; quaternized hydroxyethyl cellulose; copolymer of vinylpyrrolidone and quaternized dimethylaminoethyl methacrylate; acrylamide-dimethylaminoethyl methacrylate methyl chloride copolymer; copolymer of vinylpyrrolidone and quaternized vinylimidazole; copolymer of acrylic acid and diallyldimethylammonium chloride; copolymer of vinylpyrrolidone and methacrylamidopropyl trimethylammonium; poly(acrylamide 2-methacryloxyethyltrimethyl ammonium chloride); poly(2-methacryloxyethyltrimethylammonium chloride); terpolymer of acrylic acid, acrylamide and diallyldimethylammonium chloride; poly[oxyethylene(dimethylimino)ethylene (dimethylimino)ethylene dichloride]; terpolymer of vinylcaprolactam, vinylpyrrolidone, and quaternized vinylimidazole; polyquaternium-47 terpolymer of acrylic acid, methacrylamidopropyl trimethylammonium chloride, and methyl acrylate; guar hydroxypropyltrimonium chloride; poly(ethyleneimine) (PEI); poly-L-(lysine) (PLL); poly[2-(N,N-dimethylamino)ethyl methacrylate](PDMAEMA) and chitosan; cellulose, 2-(2-hydroxy-3-(trimethylammonium)propoxy)ethyl ether chloride, and combinations thereof.

In some embodiments, the cationic polymer comprises a combination of two or more cationic functional groups, such as, trimethylammonium chloride, quaternized vinylimidazole.

In some embodiments, the cationic polymer is present in the treatment fluids in the amount of from about 0.01% to about 5% by volume of the fluid system.

Anionic Surfactants

The fluids of the disclosure include an anionic surfactant. The anionic surfactant comprises at least one selected from the group consisting of alpha olefin sulfonate, alkylether sulfates, alkyl phosphonates, alkane sulfonates, fatty acid salts, and arylsulfonic acid salts, and mixtures thereof. A commercially available preferred surfactant is AQF-2™ surfactant.

Generally, the surfactant is present in the treating fluid composition in an amount sufficient to form an ion-pair association with enough of the charged polymer units to produce an increase in viscosity. Preferably, the surfactant is present in the treating fluid composition in an amount in the range of from about 0.05% to about 1.0% by weight thereof, more preferably from about 0.1% to about 0.6%, and most preferably from about 0.2% to about 0.5%.

Proppants

One component of the treatment fluids of the disclosure includes proppants. In some embodiments, the proppants may be an inert material, and may be sized (e.g., a suitable particle size distribution) based upon the characteristics of the void space to be placed in.

Materials suitable for proppant particulates may comprise any material comprising inorganic or plant-based materials suitable for use in subterranean operations. Suitable materials include, but are not limited to, sand; bauxite; ceramic materials; glass materials; materials comprising polytetrafluoroethylene; nut shell pieces; cured resinous particulates comprising nut shell pieces; seed shell pieces; cured resinous particulates comprising seed shell pieces; fruit pit pieces; cured resinous particulates comprising fruit pit pieces, wood; and any combination thereof. The mean proppant particulate size generally may range from about 2 mesh to about 400 mesh on the U.S. Sieve Series; however, in certain circumstances, other mean proppant particulate sizes may be desired and will be entirely suitable for practice of the embodiments disclosed herein. In particular embodiments, preferred mean proppant particulate size distribution ranges are one or more of 6/12, 8/16, 12/20, 16/30, 20/40, 30/50, 40/60, 40/70, or 50/70 mesh. It should be understood that the term “particulate,” as used herein, includes all known shapes of materials, including substantially spherical materials; fibrous materials; polygonal materials (such as cubic materials); and any combination thereof. In certain embodiments, the particulates may be present in the treatment fluids in an amount in the range of from an upper limit of about 30 pounds per gallon (“ppg”), 25 ppg, 20 ppg, 15 ppg, and 10 ppg to a lower limit of about 0.5 ppg, 1 ppg, 2 ppg, 4 ppg, 6 ppg, 8 ppg, and 10 ppg by volume of the treatment fluids.

Consolidating Agents

The consolidating agents used in the compositions and methods of the present invention generally comprise any compound that is capable of minimizing particulate migration and/or modifying the stress-activated reactivity of subterranean fracture faces and other surfaces in subterranean formations. The consolidating agent may comprise compounds such as tackifying agents, resins, and combinations thereof. The consolidating agents may be present in the treatment fluids in an amount in the range from about 0.01% to 30% by weight of the composition. The type and amount of consolidating agent included in a particular composition or method of the invention may depend upon, among other factors, the temperature of the subterranean formation, the chemical composition of formations fluids, flow rate of fluids present in the formation, and the like. It is within the ability of one skilled in the art, with the benefit of this disclosure, to determine the type and amount of consolidating agent to include in the treatment fluids of the present invention to achieve the desired results.

In some embodiments, the consolidating agent may comprise a tackifying agent. A particularly preferred group of tackifying agents comprises polyamides that are liquids or in solution at the temperature of the subterranean formation such that they are, by themselves, non-hardening when introduced into the subterranean formation. A particularly preferred product is a condensation reaction product comprised of commercially available polyacids and a polyamine. Such commercial products include compounds such as mixtures of C₃₆ dibasic acids containing some trimer and higher oligomers and also small amounts of monomer acids that are reacted with polyamines. Other polyacids include trimer acids, synthetic acids produced from fatty acids, maleic anhydride, acrylic acid, and the like. Such acid compounds are commercially available from companies such as Witco Corporation, Union Camp, Chemtall, and Emery Industries. The reaction products are available from, for example, Champion Technologies, Inc. and Witco Corporation. Additional compounds which may be used as tackifying agents include liquids and solutions of, for example, polyesters, polycarbonates and polycarbamates, natural resins such as shellac and the like.

In some embodiments, the consolidating agent may comprise a resin. The term “resin” as used herein refers to any of numerous physically similar polymerized synthetics or chemically modified natural resins including thermoplastic materials and thermosetting materials. Resins suitable for use in the present disclosure include all resins known and used in the art. One type of resin coating material suitable for use in the compositions and methods of the present disclosure is a two-component epoxy based resin comprising a liquid hardenable resin component and a liquid hardening agent component. The liquid hardenable resin component is comprised of a hardenable resin and an optional solvent. The solvent may be added to the resin to reduce its viscosity for ease of handling, mixing and transferring. It is within the ability of one skilled in the art with the benefit of this disclosure to determine if and how much solvent may be needed to achieve a viscosity suitable to the subterranean conditions. Factors that may affect this decision include geographic location of the well, the surrounding weather conditions, and the desired long-term stability of the consolidating agent emulsion. An alternate way to reduce the viscosity of the hardenable resin is to heat it. This method avoids the use of a solvent altogether, which may be desirable in certain circumstances. The second component is the liquid hardening agent component, which is comprised of a hardening agent, a silane coupling agent, a surfactant, an optional hydrolyzable ester for, among other things, breaking gelled fracturing fluid films on the proppant particulates, and an optional liquid carrier fluid for, among other things, reducing the viscosity of the hardening agent component.

Examples of hardenable resins that can be used in the liquid hardenable resin component include, but are not limited to, organic resins such as bisphenol A diglycidyl ether resin, butoxymethyl butyl glycidyl ether resin, bisphenol A-epichlorohydrin resin, bisphenol F resin, polyepoxide resin, novolak resin, polyester resin, phenol-aldehyde resin, urea-aldehyde resin, furan resin, urethane resin, a glycidyl ether resin, other similar epoxide resins and combinations thereof. The hardenable resin used is included in the liquid hardenable resin component in an amount in the range of from about 5% to about 100% by weight of the liquid hardenable resin component. In some embodiments the hardenable resin used is included in the liquid hardenable resin component in an amount of about 25% to about 55% by weight of the liquid hardenable resin component. It is within the ability of one skilled in the art with the benefit of this disclosure to determine how much of the liquid hardenable resin component may be needed to achieve the desired results. Factors that may affect this decision include which type of liquid hardenable resin component and liquid hardening agent component are used.

Other Additives

In addition to the foregoing materials, it can also be desirable, in some embodiments, for other components to be present in the treatment fluid. Such additional components can include, without limitation, particulate materials, fibrous materials, bridging agents, weighting agents, gravel, corrosion inhibitors, catalysts, clay control stabilizers, biocides, bactericides, friction reducers, gases, surfactants, solubilizers, salts, scale inhibitors, foaming agents, anti-foaming agents, iron control agents, and the like.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the aqueous base fluid at a subsequent time. After the preblended liquids and the aqueous base fluid have been combined polymerization initiators and other suitable additives may be added prior to introduction into the wellbore. Those of ordinary skill in the art, with the benefit of this disclosure will be able to determine other suitable methods for the preparation of the treatments fluids of the present invention.

The methods of the present invention may be employed in any subterranean treatment where a viscoelastic treatment fluid may be used. Suitable subterranean treatments may include, but are not limited to, fracturing treatments, sand control treatments (e.g., gravel packing), cementing, diversion, and other suitable treatments where a treatment fluid of the present invention may be suitable.

In addition to the fracturing fluid, other fluids used in servicing a wellbore may also be lost to the subterranean formation while circulating the fluids in the wellbore. In particular, the fluids may enter the subterranean formation via lost circulation zones for example, depleted zones, zones of relatively low pressure, zones having naturally occurring fractures, weak zones having fracture gradients exceeded by the hydrostatic pressure of the drilling fluid, and so forth.

Wellbore and Formation

Broadly, a zone refers to an interval of rock along a wellbore that is differentiated from surrounding rocks based on hydrocarbon content or other features, such as perforations or other fluid communication with the wellbore, faults, or fractures. A treatment usually involves introducing a treatment fluid into a well. As used herein, a treatment fluid is a fluid used in a treatment. Unless the context otherwise requires, the word treatment in the term “treatment fluid” does not necessarily imply any particular treatment or action by the fluid. If a treatment fluid is to be used in a relatively small volume, for example less than about 200 barrels, it is sometimes referred to in the art as a slug or pill. As used herein, a treatment zone refers to an interval of rock along a wellbore into which a treatment fluid is directed to flow from the wellbore. Further, as used herein, into a treatment zone means into and through the wellhead and, additionally, through the wellbore and into the treatment zone.

As used herein, into a subterranean formation can include introducing at least into and/or through a wellbore in the subterranean formation. According to various techniques known in the art, equipment, tools, or well fluids can be directed from a wellhead into any desired portion of the wellbore. Additionally, a well fluid can be directed from a portion of the wellbore into the rock matrix of a zone.

In various embodiments, systems configured for delivering the treatment fluids described herein to a downhole location are described. In various embodiments, the systems can comprise a pump fluidly coupled to a tubular, the tubular containing the treatment fluids, and any additional additives, disclosed herein.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

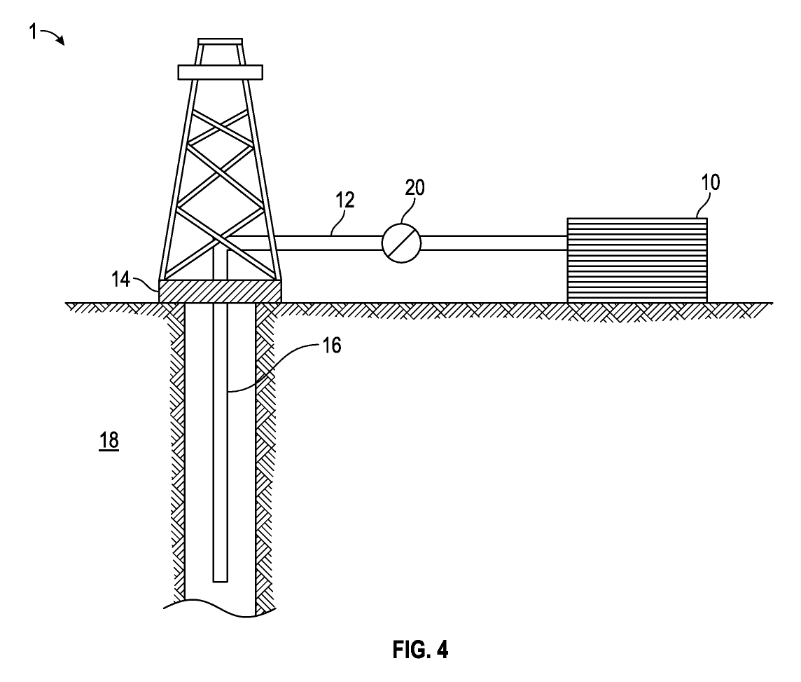

FIG. 4 shows an illustrative schematic of a system that can deliver treatment fluids of the embodiments disclosed herein to a downhole location, according to one or more embodiments. It should be noted that while FIG. 4 generally depicts a land-based system, it is to be recognized that like systems may be operated in subsea locations as well. As depicted in FIG. 4, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 4 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 4, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 4.

The invention having been generally described, the following examples are given as particular embodiments of the invention and to demonstrate the practice and advantages hereof. It is understood that the examples are given by way of illustration and are not intended to limit the specification or the claims to follow in any manner.

### EXAMPLES

### Experimental Procedure

The fluids were generally prepared by observing the order of addition disclosed in Table 1, combining the components, and then allowing them to settle at room temperature, or at various increasing temperatures. Viscosity profiles were generated using a Chandler 5550 viscometer.

Table 1 reflects the compositions and results

TABLE 1
Bench Top Experiments

| Additives | Observation |
|---|---|
| 1) 50 lb/1000 gal Cat-HEC | Fluid had viscous domains, but was |
| 2) 2 gal/1000 gal SURF1 | very ‘choppy’ and seemed less |
| | viscous than the base fluid of |
| | hydrated polymer. Depending on |
| | the mixing rate, a large fibrous knot |
| | would form on the blender blades |
| 1) 2 gal/1000 gal SURF1 | Highly viscous fluid formed, |
| 2) 50 lb/1000 gal Cat-HEC | appeared crosslinked but did not lip |
| | like traditional crosslink fluids |
| 1) 4 gal/1000 gal SURF1 | Cloudy, viscosity ~15 cP, very |
| 2) 50 lb/1000 gal Cat-HEC | grainy, perhaps syneresis |
| 1) 0.5 gal/1000 gal SURF1 | Viscous (but significantly less than |
| 2) 50 lb/1000 gal Cat-HEC | 2 gal/1000 gal) fluid formed, |
| | appeared to have more lipping |
| | action compared to 2 gal/1000 gal |
| | SURF1 |
| 1) 4 gal/1000 gal SURF1 | Cloudy, viscosity ~15 cP, very |
| 2) 40 lb/1000 gal Cat-HEC | grainy, perhaps syneresis |
| 1) 2 gal/1000 gal SURF1 | Highly viscous (slightly less than 50 lb/ |
| 2) 40 lb/1000 gal Cat-HEC | 1000 gal) fluid formed, but did |
| | not lip like traditional crosslink |
| | fluids |
| 1) 1.5 gal/1000 gal SURF1 | Viscous (less than 40 lb/1000 gal |
| 2) 30 lb/1000 gal Cat-HEC | experiment) fluid formed, but did |
| | not lip like traditional crosslink |
| | fluids |
| 1) 1 gal/1000 gal SURF1 | Slightly viscous fluid formed, |
| 2) 25 lb/1000 gal Cat-HEC | structure appeared significantly |
| | weaker than other experiments. |

SURF1 is a surfactant with a composition of about 10% diethylene glycol, about 30% ethylene glycol monobutyl ether, about 45% α-olefin sulfonate, and about 15% water.

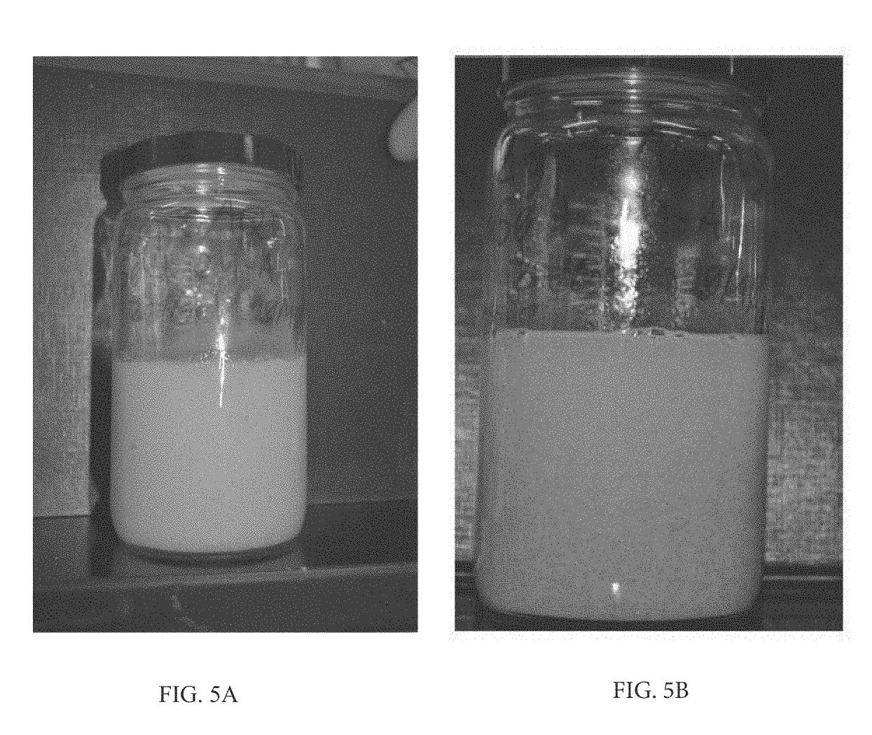

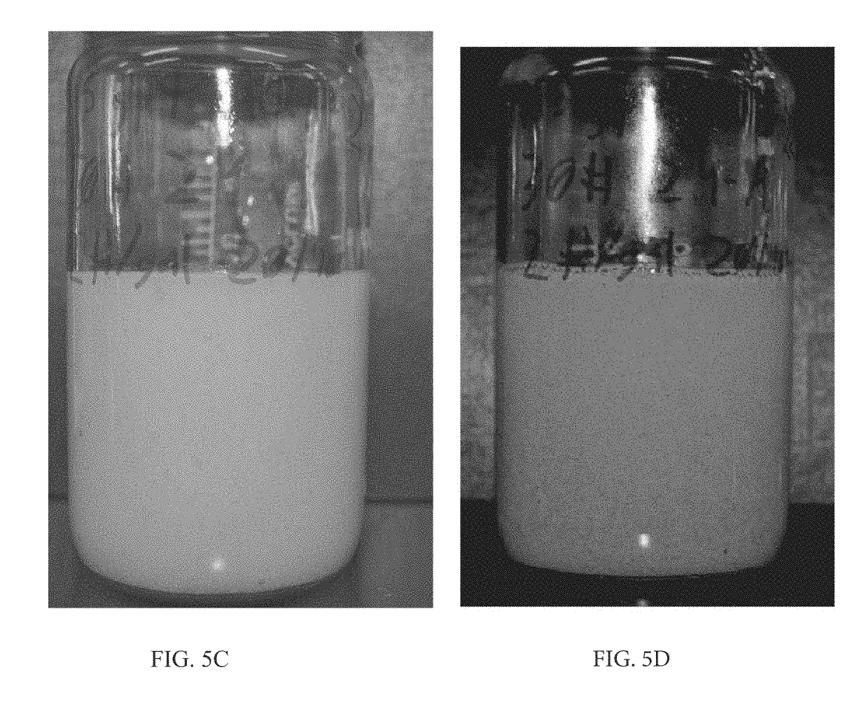

Based upon these experiments, the 50 lb/1000 gal formulation using 2 gal/1000 gal of SURF1 surfactant and the 30 lb/1000 gal formulation were re-made with the addition of 2 lb/gal sand (20/40 mesh) and placed in bottles and left at room temperature to investigate the fluids' ability to suspend proppant. No noticeable proppant settling was observed up to 48 hours (FIGS. 5A-D). FIG. 5A has a 50 lb/1000 gal Cat-HEC/anion surfactant formulation with 2 lb/gal sand. FIG. 5B shoes the results after 48 hours of settling. FIG. 5C has a 30 lb/1000 gal Cat-HEC/anion surfactant formulation with 2 lb/gal sand and FIG. 5D shows the results after settling for 48 hours. Both sets are still suspending proppant after 48 hours. The ability to transport proppant is essential and these experiments demonstrated that even though the polymer/surfactant fluids appeared to have different physical characteristics from borate and metal crosslinked fluids they could still suspend proppant.

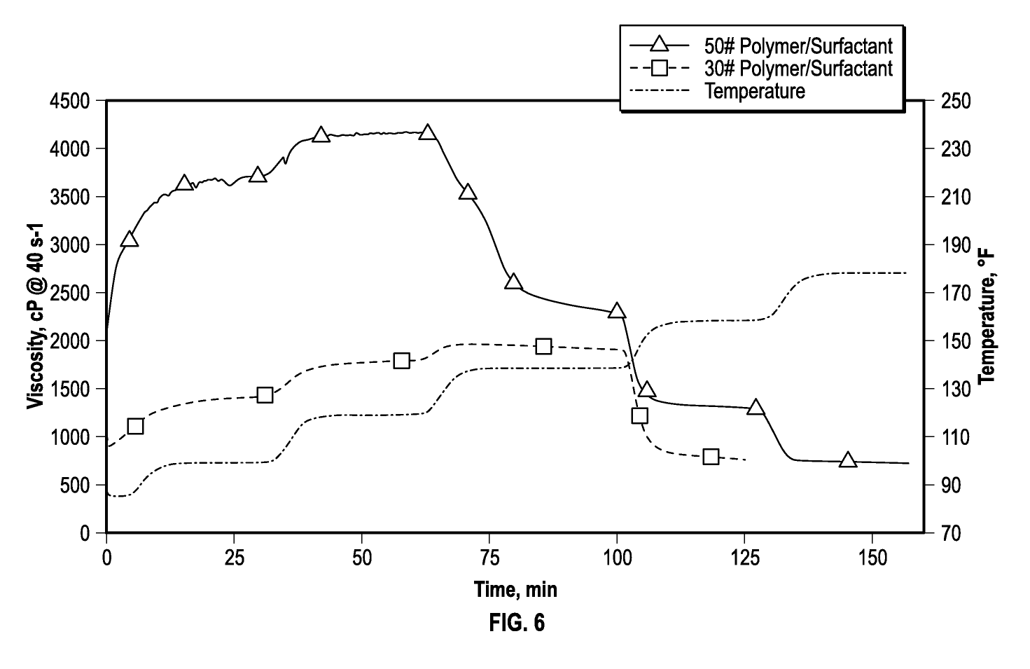

Chandler experiments were also conducted using the same 30 and 50 lb/1000 gal formulations to access thermal and shear stability of these fluids. The viscosity profiles in FIG. 6 were obtained using the Chandler 5550 with a constant shear rate of 40 s⁻¹ while periodically increasing the temperature. The maximum stable viscosity recorded for the 50 b/1000 gal formulation was 4000 cP at 120° F., increasing the temperature above 140° F. resulted in large drops in viscosity. However, at elevated temperatures above 140° F. the fluid still maintained a high stable viscosity, ˜1300 cP at 160° F. and ˜700 cP at 180° F. The 30 lb/1000 gal fluid formulation showed a similar trend. The 30 lb/1000 gal fluid maximum stable viscosity was ˜1800 cP at 140° F. As the temperature was increased to 160° F., the viscosity was stable but it dropped to ˜700 cP. Unusual fluid behavior was recorded for the 50 and 30 lb/1000 gal formulations as fluid temperature was increased from room temperature to 120 and 140° F. The viscosity of the fluids increased with increasing temperature and remained constant once the temperature was held constant. This behavior is contrary to borate and metal crosslinked fluids, which once fully crosslinked, tend to decrease in viscosity with any increase in temperature. Cat-HEC/anionic surfactant fluids can yield high viscosity fluids which appear to increase dramatically in viscosity as temperature increases over a certain range, which may suggest that the mechanism of building viscosity is different than borate and metal crosslinked systems. This unique fluid property may allow a single Cat-HEC/anionic surfactant fluid formulation to be used over a wide temperature range.

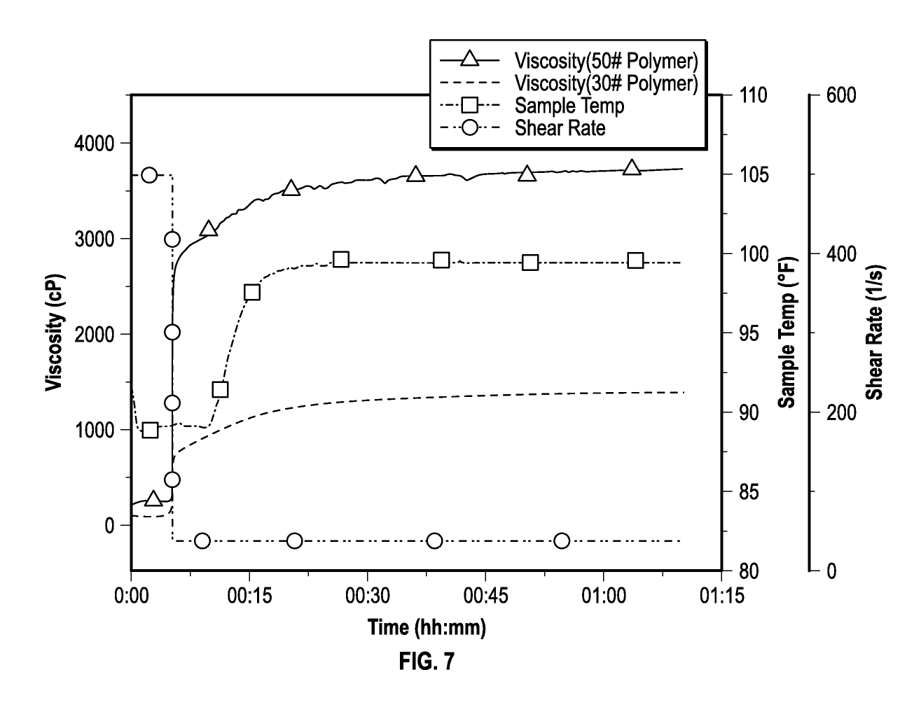

Metal crosslinkers are preferred for higher temperature stability, but shear sensitivity of the metal crosslinker is one of the major challenges in the field. This high viscosity Cat-HEC/anionic surfactant system showed low shear sensitivity compared to traditional metal crosslinked fluids, which allows for essentially residue-free, shear tolerant fluids. FIG. 7 shows the shear stability of the 30 and 50 lb/1000 gal formulations of the Cat-HEC/anionic surfactant systems after exposure to high shear rates. After the fluid was sheared for 5 min at 500 s⁻¹, near maximum viscosity for each formulation was quickly recovered. If the viscosities of FIGS. 6 and 7 are compared at 40 s⁻¹ at 100° F., it is clear that the high shear rate did not significantly degrade the fluid's viscosity.

Embodiments disclosed herein include:

A: A method of treating in a subterranean formation comprises: combining an aqueous base fluid and an anionic surfactant to form a first solution; hydrating a cationic polymer with the first solution to form a viscous fluid; combining the viscous fluid with a proppant thereby forming a treatment fluid; and introducing the treatment fluid into the subterranean formation.

B: A method of making a well treatment fluid comprises: combining an aqueous base fluid and an anionic surfactant to form a first solution; hydrating a cationic polymer with the first solution to form a viscous fluid; and combining the viscous fluid with a proppant thereby forming a treatment fluid.

C: A method of treating in a subterranean formation comprising: combining an aqueous base fluid and an anionic surfactant to form a first solution; hydrating a cationic polymer with the first solution to form a viscous fluid; combining the viscous fluid with a proppant thereby forming a treatment fluid; and introducing the treatment fluid into the subterranean formation under conditions effective to create at least one fracture therein.

Each of embodiments A, B, and C may have one or more of the following additional elements in any combination: Element 1: wherein the aqueous base fluid comprises at least one fluid selected from water, brine, slick water, and combinations thereof. Element 2: wherein the anionic surfactant comprises at least one selected from the group consisting of alpha olefin sulfonate, alkylether sulfates, alkyl phosphonates, alkane sulfonates, fatty acid salts, and arylsulfonic acid salts, and mixtures thereof. Element 3: wherein the anionic surfactant comprises diethylene glycol, ethylene glycol monobutyl ether, α-olefin sulfonate, and water. Element 4: wherein the cationic polymer is partially hydrated before it is combined with the first solution. Element 5: wherein the proppants are at least one selected from the group consisting of sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combination thereof. Element 6: wherein the cationic polymer comprises at least one selected from the group consisting of cationic polyacrylamide copolymers, cationic guar, cationic cellulose derivatives, cationic polysaccharide derivatives, choline methacrylate, alkyl substituted nitrogen compounds, aryl substituted nitrogen compounds, alkyl-aryl substituted nitrogen compounds, and mixtures thereof. Element 7: wherein the cationic polymer is cationic hydroxy ethyl cellulose. Element 8: wherein the subterranean formation comprises at least one fracture and wherein the introducing further comprises placing at least a portion of the treatment fluid into the at least one fracture. Element 9: further comprising adding a consolidating agent to the treatment fluid at a time of at least one of before the introducing of the treatment fluid into the subterranean formation, during the introducing of the treatment fluid, after the introducing the treatment fluid, and combinations thereof. Element 10: wherein a combining, hydrating, and introducing utilize at least one of a pump, a mixer, and combinations thereof.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of treating in a subterranean formation comprising:
combining an aqueous base fluid and an anionic surfactant to form a first solution;
hydrating a cationic polymer with the first solution to form a viscous fluid;
combining the viscous fluid with a proppant thereby forming a treatment fluid; and
introducing the treatment fluid into the subterranean formation.

2. The method of claim 1, wherein the aqueous base fluid comprises at least one fluid selected from water, brine, slick water, and combinations thereof.

3. The method of claim 1, wherein the anionic surfactant comprises at least one selected from the group consisting of alpha olefin sulfonate, alkylether sulfates, alkyl phosphonates, alkane sulfonates, fatty acid salts, and arylsulfonic acid salts, and mixtures thereof.

4. The method of claim 3, wherein the anionic surfactant comprises diethylene glycol, ethylene glycol monobutyl ether, α-olefin sulfonate, and water.

5. The method of claim 1, wherein the cationic polymer is partially hydrated before it is combined with the first solution.

6. The method of claim 1, wherein the proppants are at least one selected from the group consisting of sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combination thereof.

7. The method of claim 1, wherein the cationic polymer comprises at least one selected from the group consisting of cationic polyacrylamide copolymers, cationic guar, cationic cellulose derivatives, cationic polysaccharide derivatives, choline methacrylate, alkyl substituted nitrogen compounds, aryl substituted nitrogen compounds, alkyl-aryl substituted nitrogen compounds, and mixtures thereof.

8. The method of claim 7, wherein the cationic polymer is cationic hydroxy ethyl cellulose.

9. The method of claim 1, wherein the subterranean formation comprises at least one fracture and wherein the introducing further comprises placing at least a portion of the treatment fluid into the at least one fracture.

10. The method of claim 1, further comprising adding a consolidating agent to the treatment fluid at a time of at least one of before the introducing of the treatment fluid into the subterranean formation, during the introducing of the treatment fluid, after the introducing the treatment fluid, and combinations thereof.

11. The method of claim 1, wherein a combining, hydrating, and introducing utilize at least one of a pump, a mixer, and combinations thereof.

12. A method of making a well treatment fluid comprising:
combining an aqueous base fluid and an anionic surfactant to form a first solution;
hydrating a cationic polymer with the first solution to form a viscous fluid; and
combining the viscous fluid with a proppant thereby forming a treatment fluid.

13. The method of claim 12, wherein the aqueous base fluid comprises at least one fluid selected from water, brine, slick water, and combinations thereof.

14. The method of claim 12, wherein the anionic surfactant comprises at least one selected from the group consisting of alpha olefin sulfonate, alkylether sulfates, alkyl phosphonates, alkane sulfonates, fatty acid salts, and arylsulfonic acid salts, and mixtures thereof.

15. The method of claim 14, wherein the anionic surfactant comprises diethylene glycol, ethylene glycol monobutyl ether, α-olefin sulfonate, and water.

16. The method of claim 12, wherein the cationic polymer is partially hydrated before it is combined with the first solution.

17. The method of claim 12, wherein the proppants are at least one selected from the group consisting of sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combination thereof.

18. The method of claim 12, wherein the cationic polymer comprises at least one selected from the group consisting of cationic polyacrylamide copolymers, cationic guar, cationic cellulose derivatives, cationic polysaccharide derivatives, choline methacrylate, alkyl substituted nitrogen compounds, aryl substituted nitrogen compounds, alkyl-aryl substituted nitrogen compounds, and mixtures thereof.

19. The method of claim 18, wherein the cationic polymer is cationic hydroxy ethyl cellulose.

20. A method of forming one or more fractures in a subterranean formation comprising:
combining an aqueous base fluid and an anionic surfactant to form a first solution;
hydrating a cationic polymer with the first solution to form a viscous fluid;
combining the viscous fluid with a proppant thereby forming a treatment fluid; and
introducing the treatment fluid into the subterranean formation under conditions effective to create at least one fracture therein.
